(19) United States
(12) Patent Application Publication
(10) Pub. No.: US 2002/0013541 A1
(43) Pub. Date: Jan. 31, 2002

(54) Massaging device to be inserted in the back of a massage chair or the like

(75) Inventor: Egidio Marcantoni, Pesaro (IT)

Correspondence Address: MODIANO & ASSOCIATI, Via Meravigli, 16, Milano, 20123, IT

(73) Assignee: CIAR S.p.A.

(21) Appl. No.: 09/906,721

(22) Filed: Jul. 18, 2001

(30) Foreign Application Priority Data
Jul. 27, 2000 (IT) MI2000A001726

(51) Int. Cl. A61H 7/00

(52) U.S. Cl. 601/99; 601/101

(57) ABSTRACT

A massaging device to be inserted in the back of a massage chair or the like, comprising a frame suitable to support massage wheels which are rotationally actuated by at least one gearmotor; the massage wheels are directly connected to the shaft of the gearmotor by way of an element suitable to produce an oscillation of the massage wheels so that the longitudinal axis of the massage wheels oscillates, during the rotation of the wheels, with respect to the axis that passes through the center of the wheels.

### BACKGROUND OF THE INVENTION

The present invention relates to a massaging device to be inserted in the back of a massage chair or the like.

More particularly, the invention relates to a massaging device which is s capable of performing both stretching and kneading massages.

It is known that massaging devices to be inserted in the back of massage chairs or the like generally comprise a frame which supports, so that it can rotate about its own axis, at least one shaft which is arranged with its axis parallel and substantially horizontal. The shaft has, at its opposite longitudinal ends, circular cross-sectional eccentric portions acting as cranks, each of which rotatably engages an arm supporting, at its opposite end, a massage wheel, freely rotatable about its own axis, which is usually slightly inclined with respect to a horizontal direction being parallel to the axis of the shaft whereto the wheel is connected.

Each of said arms is pivoted, proximate to its intermediate portion, to an eccentric portion of the shaft, and the connection of each of the arms to the eccentric portion is provided by a connecting rod. Said connecting rod is articulated, at its intermediate point, so as to allow to vary its useful length, and the connection to the corresponding eccentric portion of the shaft is provided by means of a spherical joint.

The eccentric portions of the shaft, which engage said arms, have an axis which is slightly inclined with respect to the axis of the shaft. Owing to the geometry of the eccentric portions, the rotary actuation of the shaft causes an oscillation of the wheel. The wheels are the elements of the massaging device that act on the user's back, by oscillating about a respective axis which passes through the intersection point of the axis of the eccentric portion of shaft, i.e., a movement in a horizontal direction, thus achieving the so-called stretching massage, and two movements in a vertical direction, providing the so-called tapping massage.

Kneading-type massage is provided by means of lever systems which connect the shaft to the wheels so as to make them perform a movement in which the wheel is arranged at an angle with respect to a longitudinal axis which coincides with the axis of the back of the chair in which the massaging device is inserted.

However, known types of device, while being highly effective in terms of the quality of the massage being offered, are affected by drawbacks linked to the high cost of their mechanical part (arms, levers and the like), which is preponderant in order to be able to perform the above cited types of massage.

### SUMMARY OF THE INVENTION

The aim of the present invention is to provide a massaging device to be inserted in the back of a massage chair and the like which allows to perform kneading-type massage in a manner which is extremely simplified with respect to known devices.

Within this aim, an object of the present invention is to provide a massaging device to be inserted in the back of massage chairs and the like which can provide stretching-type massage in addition to kneading-type massage with a reduced number of mechanical components.

Another object of the present invention is to provide a massaging device to be inserted in the back of massage chairs and the like which combines constructive simplicity with excellent performance in terms of massage quality.

Another object of the present invention is to provide a massaging device to be inserted in the back of massage chairs and the like which is highly reliable, relatively simple to manufacture and at competitive costs.

This aim and these and other objects which will become better apparent hereinafter are achieved by a massaging device to be inserted in the back of a massage chair or the like, comprising a frame which is adapted to support massage wheels which are rotationally actuated by at least one gearmotor, characterized in that said massage wheels are directly connected to the shaft of said gearmotor through means which are adapted to produce an oscillation of said massage wheels so that the longitudinal axis of said massage wheels oscillates, during said rotation of the wheels, with respect to the axis that passes through the center of said wheels.

### BRIEF DESCRIPTION OF THE DRAWINGS

Further characteristics and advantages will become better apparent from the description of a preferred but not exclusive embodiment of the massaging device according to the invention, illustrated only by way of non-limitative example in the accompanying drawings, wherein:

FIG. 1 is a perspective view of the massaging device according to the present invention, inserted in a frame which in turn is designed to be inserted in the back of a massage chair and the like;

FIG. 2 is an exploded plan view of the massaging device according to the present invention;

FIG. 3 is a partially exploded perspective view of the massaging device according to the invention; and

FIG. 4 is a plan view of the angle assumed by the massage wheels during their rotation in the massaging device according to the present invention.

### DESCRIPTION OF THE PREFERRED EMBODIMENTS

With reference to the figures, the massaging device according to the present invention, generally designated by the reference numeral 1, comprises a frame 2 which is suitable to support at least one gearmotor 3 provided with a motor shaft 4 to which at least one pair of massage wheels 5 can be connected.

The particularity of the invention resides in that the massage wheels 5 are directly connected to the shaft 4 of the gearmotor 3, so that they rotate in a manner in which the axis that is perpendicular to the axis that passes through the hub of the wheel oscillates so as to form an angle with respect to the horizontal axis that passes through the center of the wheel.

As shown in FIG. 4, the oscillation performed by the wheel 5 during its rotation about the shaft 4 of the gearmotor 3 is such that in plan view the axis 7, which is perpendicular to the axis 8 that passes through the center of the wheel, is moved from a position in which the axis 7 is actually perpendicular to the axis 8 to positions in which the axis 7 is at an angle to the axis 8.

The oscillation of the axis 7 of the wheel 5, together with the rotation of said wheel about the shaft 4 of the gearmotor 3, allows to perform the socalled kneading-type massage.

The rotation of the wheels 5 about the axis of the shaft 4 of the gearmotor 3 is accompanied by an oscillating motion of said wheels, as already explained. Such oscillating motion is achieved by connecting the wheels 5 to the shaft 4 through means suitable to produce a rotation of the wheel 5 which oscillates with respect to the axis 8 of the shaft 4 of the gearmotor 3. Said means conveniently comprise a bush 10 on which a bearing 11 is fixed at an angle which allows the rotation of the wheel 5.

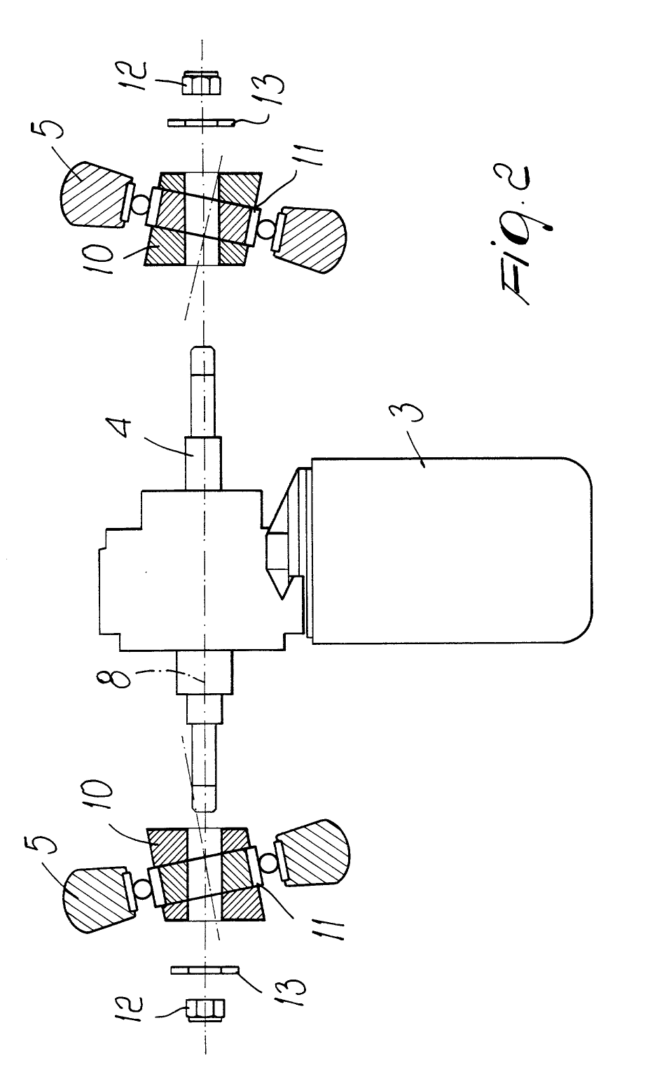

In particular, as shown in FIG. 2, the bearing 11 is mounted on the bush 10, which is shaped like a parallelogram, so that the faces of the bearing lie at an angle to the faces of the bush 10 whose faces lie at right angles to the axis 8 of the shaft 4 of the gearmotor 3.

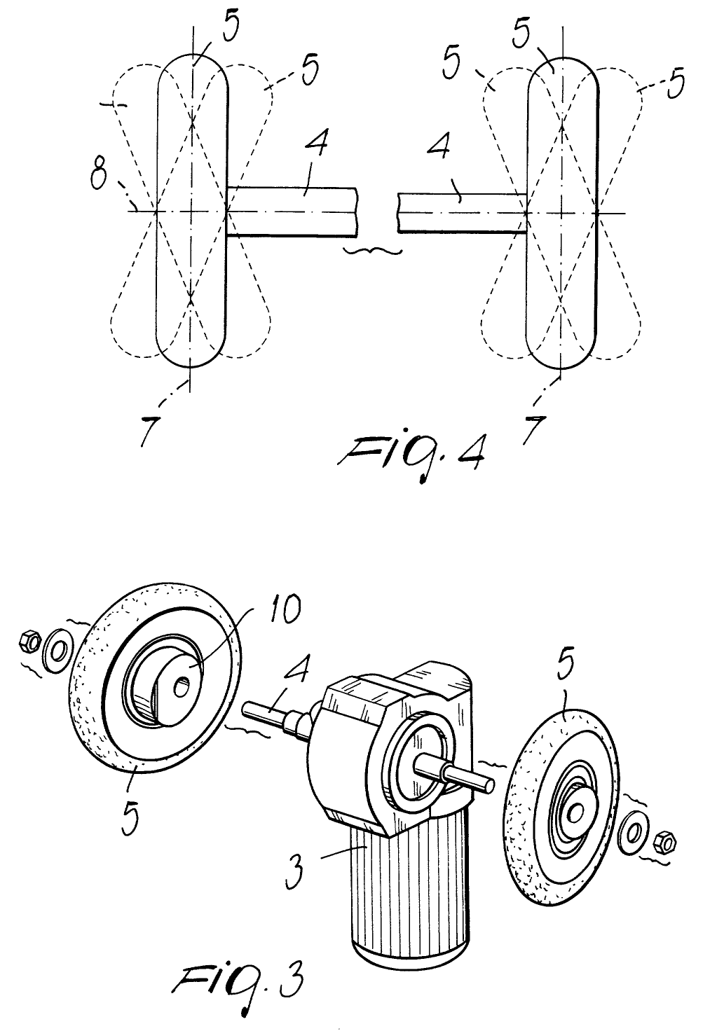

Therefore, as shown in detail also in FIG. 3, the particular configuration of the bush 10 allows the wheel 5 to turn about the shaft 4 of the gearmotor 3 so that the longitudinal wheel axis 7 oscillates with respect to its arrangement at right angles to the axis 8 that passes through the wheel hub.

Finally, the wheel 5 connected by means of the bearing 11 to the bush 10 fixed to the shaft 4 of the gearmotor 3 is fixed by locking it with a nut 12 and interposing a washer 13.

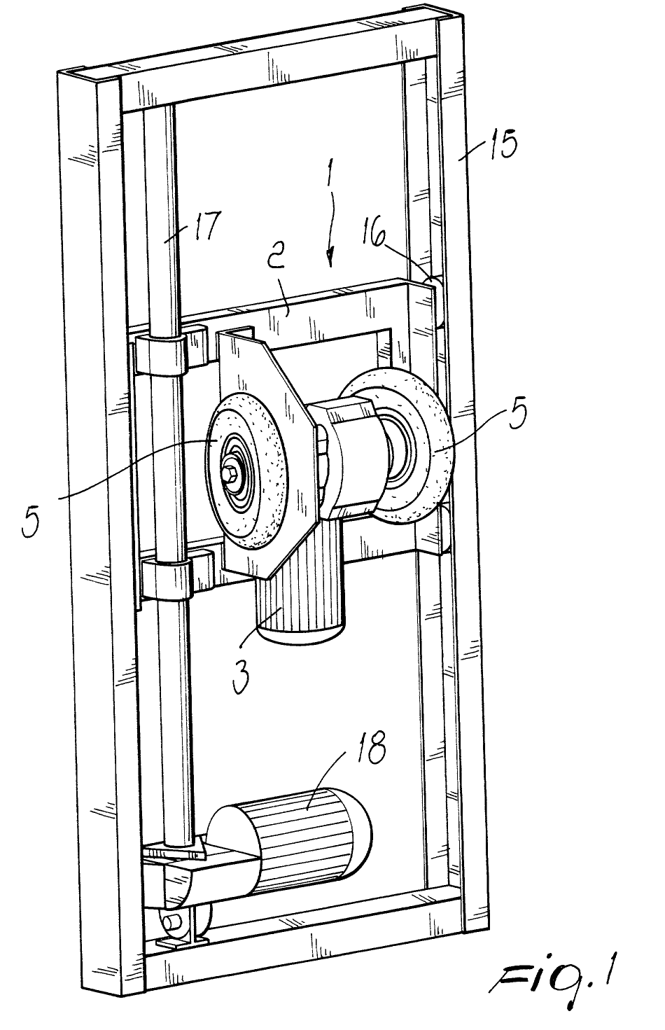

As shown in FIG. 1, the frame 2 can be conveniently inserted slidingly within a framework 15 thanks to the presence of wheels 16 which allow the frame 1 to slide within the lateral profiles of the framework 15.

The frame 2 further slides, by means of the wheels 16, along a threaded shaft 17 being actuated by a gearmotor 18 which is placed in a lower position with respect to the gearmotor 3.

In this manner, the sliding of the frame 2 along the threaded shaft 17, together with the rotation of the massage wheels 5, allows to perform stretching-type massage in combination with kneading-type massage.

It is of course possible to have a single type of massage, i.e., kneading-type massage, if the frame 2 is directly inserted in the back of a massage chair without the presence of the framework 15.

In practice it has been found that the massage device according to the invention fully achieves the intended aim and objects, since it allows to perform kneading-type massage without having to resort to any type of lever mechanism, using instead a direct connection between the massage wheels and the gearmotor shaft.

The device thus conceived is susceptible of numerous modifications and variations, all of which are within the scope of the appended claims; all the details may further be replaced with other technically equivalent elements.

In practice, the materials used, so long as they are compatible with the specific use, as well as the shapes and the dimensions, may be any according to requirements and to the state of the art.

The disclosures in Italian Patent Application No. M12000A001726 from which this application claims priority are incorporated herein by reference.

What is claimed is:

1. A massaging device for insertion in the back of a massage chair comprising:
a supporting frame;
massage wheels, supported at said frame for rotation about a rotation axis passing through centers thereof;
at least one actuation gearmotor having a rotating shaft for actuation of said massage wheels; and
oscillation supporting means for support of said wheels at, and direct connection thereof to said shaft, said oscillation and supporting means providing an oscillation of said wheels during which longitudinal diametral axes of the wheels oscillate with respect to said rotation axis.

2. The device of claim 1, wherein said oscillation and supporting means comprise, for each of said massage wheels, a bearing and a bush, said bush being connected to said shaft of said gearmotor, and said wheel being mounted on said bush by way of said bearing, with said bush being shaped so as to have a central axis thereof that passes through a center of said bearing and through the center of a said wheel which is at an angle to said rotation axis of said gearmotor shaft.

3. The device of claim 2, comprising a pair of massage wheels arranged at the opposite ends of said gearmotor shaft.

4. The device of claim 3, further comprising a nut and a washer, said massage wheels being locked on said gearmotor shaft by way of said nut and an interposed washer.

5. The device of claim 2, further comprising a framework; a threaded shaft, which is arranged longitudinally along the sides of said framework; and a motion gearmotor for rotation actuation of said threaded shaft, said frame being accommodated in said framework and actuated for sliding motion along said threaded shaft.

6. The device of claim 5, wherein said frame is provided with sliding wheels for translational motion along said framework upon actuation of said threaded shaft.
